(19) United States
(12) Patent Application Publication
(10) Pub. No.: US 2014/0262770 A1
(43) Pub. Date: Sep. 18, 2014

(54) ELECTROCHEMICAL CELL SYSTEM FOR RAPID EVALUATION OF ELECTROCHEMICAL PROCESSES AND MATERIALS USED THEREIN

(71) Applicant: Liquid Light, Inc., Monmouth Junction, NJ (US)

(72) Inventors: Theodore J. Kramer, San Francisco, CA (US); Emily B. Cole, Monmouth Junction, NJ (US); Kyle Teamey, Monmouth Junction, NJ (US)

(73) Assignee: Liquid Light, Inc., Monmouth Junction, NJ (US)

(21) Appl. No.: 14/209,730

(22) Filed: Mar. 13, 2014

Related U.S. Application Data
(60) Provisional application No. 61/784,922, filed on Mar. 14, 2013.

(51) Int. Cl. G01N 27/403

(52) U.S. Cl. CPC G01N 27/403
USPC 204/400

(57) ABSTRACT

Disclosed is a system for fabricating an electrochemical cell that includes switchable components for combinatorial evaluation of materials, solvents, membranes, separators and the like for electrochemical applications. The system includes at least one cell block and at least one electrode plate.

### CROSS REFERENCE TO RELATED APPLICATIONS

This application claims the benefit of U.S. Provisional Application Ser. No. 61/784,922 filed Mar. 14, 2013 and which is hereby incorporated herein in its entirety.

### FIELD

The present invention generally relates to a system for fabricating an electrochemical cell. More particularly, the invention is a system that includes switchable components for combinatorial evaluation of materials, solvents, membranes, separators and the like for electrochemical applications.

### BRIEF SUMMARY

The current paradigm for screening of bulk electrode materials (foils, plates, pellets, etc.), solvents, electrolytes, and components (membranes, separators, etc.) for electrochemical cells and reactions relies on low throughput experiments conducted using conventional glassware or slow-to-assemble custom apparatus. Thus, testing components that might be used in an electrochemical reaction, as well as varying and optimizing the electrochemical reaction itself is time consuming. There is a need in the art for a system that allows for rapid and repetitive testing and evaluation of materials that can be utilized in evaluating, developing and optimizing electrochemical reactions and materials and components used in electrochemical reactions.

In summary, the invention is a system that can be used for fabricating an electrochemical cell comprising a first cell block and a first electrode plate attachable to the first cell block. The first cell block includes a front surface, a back surface and a top surface, in which the front surface and the back surface are substantially parallel and the top surface is substantially perpendicular to the front surface and the back surface. The first cell block includes an opening in the front surface and extending through the first cell block to an opening in the back surface to form a first channel extending from the front surface to the back surface. The first cell block also includes a third opening in the top surface extending through the first cell block from the top surface to the first channel to form a second channel, wherein the first channel and second channel are substantially perpendicular to one another. The first electrode plate includes a front surface, a back surface and a top surface, the front surface and the back surface being substantially parallel and the top surface being substantially perpendicular to the front surface and the back surface. A first opening in the front surface of the first electrode plate defines a cavity. A second opening in the first electrode plate is in the top surface or the back surface and the first opening connects to the second opening. The system can include a second electrode plate that cab be the same as or different from the first electrode plate. The second electrode plate may be attachable to the first cell block or a different cell block.

The first cell block can also include alignment openings in the front and back surfaces for aligning and/or attaching the first cell block with the first electrode plate. In embodiments, the first cell block can further have a lower hole extending from the right or left surface of the first cell block to the first channel and an upper hole between the lower hole and the top of the first cell block extending from the right or left surface of the first cell block to the first channel or the second channel. In some embodiments, there is a second lower hole in the first cell block extending from the left or right surface of the first cell block opposite the surface having the lower hole to the first channel.

Embodiments of the first electrode plate can also include alignment openings in the front and back surfaces for aligning and/or attaching the first electrode plate to the first cell block. The second opening in the first electrode plate can be in the top surface with a bore connecting the cavity to the second opening and the back surface of the first electrode plate being solid. In other embodiments, the second opening in the first electrode plate is in the back surface and the cavity forms a channel extending from the front surface to the back surface.

Embodiments of the system can include a separator or an electrode positionable between the first cell block and the first electrode plate. In some embodiments, the system includes at least one O-ring positionable between the first electrode plate and the separator or electrode or between the first cell block and the separator or electrode.

In embodiments, the system includes a second electrode plate and a second cell block and wherein the second electrode plate is attachable to a second cell block and the first cell block is attachable to the second cell block. In embodiments, the system includes a second electrode plate, a second cell block and a third cell block wherein the second electrode plate is attachable to the third cell block and the second cell block is attachable to the first cell block and the second cell block. The system can be a kit including a first electrode plate and a first cell block, and optionally one or more of a second electrode plate, a second cell block and a third cell block.

The invention also includes a single component as described above. The single component may be one or more of a cell block an electrode plate, a first cell block, a second cell block, a third cell block, a first electrode plate and a second electrode plate.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The terms “top”, “bottom”, “front”, “back”, “left” and “right” are intended to designate relative positions and not to designate absolute orientation.

FIG. 1 is a front perspective/right side view of a cell block according to an embodiment of the invention;

FIG. 2 is a front perspective/left side view of a cell block according to an embodiment of the invention;

FIG. 3 is a right side view of a cell block according to an embodiment of the invention;

FIG. 4 is a top view of a cell block according to an embodiment of the invention;

FIG. 5 is a front view of a cell block according to an embodiment of the invention;

FIG. 6 is a sectional view along the line 6-6 of the cell block of FIG. 5;

FIG. 7 is a front perspective/right side view of a first embodiment of an electrode plate according to the invention;

FIG. 8 is a back perspective/left side view of a first embodiment of an electrode plate according to the invention;

FIG. 9 is a top view of a first embodiment of an electrode plate according to the invention;

FIG. 10 is a front view of a first embodiment of an electrode plate according to the invention;

FIG. 11 is a front perspective/right side view of a second embodiment of an electrode plate according to the invention;

FIG. 12 is a back perspective/left side view of a second embodiment of an electrode plate according to the invention;

FIG. 13 is a top side view of a second embodiment of an electrode plate according to the invention;

FIG. 14 is a front view of a second embodiment of an electrode plate according to the invention;

FIG. 15 is a sectional view along the line 15-15 of the electrode plate of FIG. 14;

FIG. 16 is an exploded view of a first exemplary embodiment of an electrochemical cell according to the invention;

FIG. 17 is an exploded view of a second exemplary configuration of an electrochemical cell according to the invention; and

FIG. 18 is an exploded view of a third exemplary embodiment of an electrochemical cell according to the invention.

### DETAILED DESCRIPTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated. The present description is exemplary and explanatory only and not restrictive nor limiting of the present disclosure. The accompanying drawings, which are incorporated in and constitute a part of the specification, illustrate subject matter of the disclosure. Together, the descriptions and the drawings serve to explain but not limit the principles of the disclosure.

Described herein is a system for rapid combinatorial testing of materials, for example solvents, membranes, separators, and the like, that are useful for electrochemical processes. The system can also be utilized for evaluation of electrochemical processes themselves. Also described are methods by which electrochemical processes and materials may be tested utilizing the system. The present system includes a cell block and electrode plate that can be assembled in a variety of configurations. Electrochemical cells can be fabricated using one or both of the components described herein and can also use other components. For example, one of the two electrodes in the electrochemical cell can be in the form of an electrode attached directly to a cell block or held in place by an electrode plate having a different construction, for example a solid plate sandwiching the electrode between the plate and the cell block. The configurations allow for rapid assembly, disassembly and cleaning to allow rapid testing of chemicals, materials, and processes for use in electrochemical applications.

### Cell Block

FIGS. 1-7 illustrate an exemplary embodiment of a cell block, i.e. an electrochemical cell block 100, according to the invention. FIG. 1 is a perspective front view of the cell block 100 including a right side view, also illustrated in FIG. 3, and showing a first channel 101 or cavity extending from the front surface 100a of the cell block to the back surface. FIG. 2 is a similar perspective front view of the cell block 100 by rotating the view of FIG. 1 90° to include a left side view. In general, the first channel 101 is the cell cavity where an electrochemical reaction occurs. A lower hole 102 in the side (illustrated in the right side) may be present for introduction of a solvent or reactive species, injection of a purging gas, or saturation of solvent with a gaseous species. The lower hole 102 may extend through the entire cell block exiting at a second lower hole 103 on the opposite surface (illustrated in FIG. 2), allowing for use of the cell in a flowthrough experiment with a larger electrolyte volume and/or real-time product analysis using a variety of methods, for example by insertion of a probe. An upper hole 104 may be present to facilitate purging of the cell or as a port to collect electrochemical products, for example a gaseous product. The upper hole 104 may connect to the first channel 101 or the second channel 107. FIG. 4 illustrates a top view of the cell block 100, showing a top hole 105. The top hole 105 can be used as, for example, an insertion point for a gas-tight reference electrode, gaseous product sampling, or liquid-phase sampling. The top hole 105 may be tapped to allow ease of assembly or attachment of fittings or other apparatus. Examples of uses where tapping for any of lower hole 102, upper hole 104, and top hole 105 may be useful include, for example, attachment of gas fittings, insertion of electrodes and other connection with standard plastic and glass components and the like.

FIG. 5 is a front view of the cell block 100. As will be described further, an electrode or other material can be placed on either the front or back surface of the cell block and exposed internally to the cavity. This configuration enables a high electrode surface area relative to cavity volume (or electrode surface area to electrolyte volume when the cavity is filled with a solution) thereby facilitating tests of short duration that produce easily measureable concentrations of electrochemical products. FIG. 6 is a cross section of the embodiment of FIG. 5 taken along the line 6-6 and illustrates the internal configuration of the cavity. As seen in FIG. 6, a second channel 107 extends from the top hole 105A (shown in a tapped configuration) to the first channel 101 allowing access to the cell volume. Opening 102a in first channel 101 is the entry point from hole 102 as shown in FIG. 3

FIGS. 5-6 illustrate a concentric counter-bore 106 in the channel 101 which can be used for locating a sealing o-ring (see FIGS. 16-18) when a cell block is attached to a second cell block or to an electrode plate, for example. FIG. 5 shows clamping through holes 108 that are used for assembling the apparatus, for example for aligning and connecting cell block(s) to electrode plate(s). Precise alignment of mating cell blocks and electrode plates ensures that pressure between components is applied via opposing o-rings and is therefore compatible with sealing to delicate materials such as wafers, thin foils, pellet compacts, etc. that may be used as electrode, separator or membrane materials. In the illustrated embodiment, clamping through holes 108 are in the form of hexagonal counterbores which can prevent the rotation of hexagonal clamping elements (hexagonal threaded stand-offs and screws, for example) that can be used to connect the cell block(s) to electrode plate(s). Other configurations of the clamping through holes can be used. For example, the through holes can be circular and can be tapped to allow for direct connection with screws. Other configurations will be readily apparent to persons skilled in the art in view of the present disclosure.

The cell block 100 can be made of any suitable material. Typically, an inert material, including, but not limited to plastic, elastomer, composite, or ceramic, is utilized. The material can be transparent to light of a particular wavelength (UV, visible or IR) to allow for optoelectrochemical reactions. Inert materials can prevent contamination and the simple modular nature facilitates immersion in cleaning solution, and low trapped volume allows for ease of cleaning and rapid drying.

In an exemplary embodiment, the cell block is about 3.25 in (8.25 cm) in height, about 1.0 in (2.5 cm) thick and about 2 in (5 cm) wide. The first channel can have a diameter of about 0.78 in (2 cm) and can be positioned with a center about 1 in (2.5 cm) from the bottom of the cell block. The lower holes 102, 104, can be positioned about with a center about 1 in (2.5 cm) from the bottom of the cell block, thus entering at the center of the channel. The upper hole 103 can be positioned about with a center about 2.25 in (5.7 cm) from the bottom of the cell block. The upper and lower holes can have a diameter of about 0.2 in (0.5 cm).

### Electrode Plates

FIGS. 7-10 illustrate a first embodiment of an electrode plate 200a according to the invention and FIGS. 11-15 illustrate a second embodiment of an electrode plate 200b according to the invention. In FIGS. 7-15, like reference numbers are used to indicate common features. As described in more detail below, the electrode plate 200a, 200b is connected to a cell block 100 in fabricating an electrochemical cell. An electrode or separator material, depending on the configuration and use, can be placed and sealed between a cell block 100 and an electrode plate 200a, 200b or between two adjacent cell blocks.

The first embodiment of an electrode plate 200a includes a cavity 201 in the form of a channel extending from the front surface to the back surface of the electrode plate. One end/opening of the cavity 201 can hold an electrode for placement against a cell block, while the opposite open end enables electrical contact or connection to the electrode by mechanical contact (potentially enhanced by a conductive paste or adhesive) to the outward-facing surface of the electrode opposite the surface in contact with an adjacent cell block. Potential contamination of electrolyte in the cell (i.e. channel 101) by external electrical components is avoided by fully isolating these electrical connections from the electrochemical chamber.

In the second embodiment of an electrode plate 200b, only the front surface is open to the cavity 201 and the back surface of the electrode plate is solid, thus forming a blind hole or cavity. In an exemplary use of this second embodiment, a membrane or separator material is placed between the electrode plate 200b and the cell block 100. The cavity 201 can be used as an electrolyte compartment. FIG. 14 is a top view of the electrode plate 200b showing an insertion port 211. As seen most clearly in the cross section of FIG. 15 taken along the line 15-15 of FIG. 14, the insertion port and the cavity are connected through a bore 212. The insertion port enables the insertion of an electrode into the cavity 209 without breaking the seal made to a mating cell block via membrane or separator material. The insertion port 211 also facilitates rapid electrode change-out as well as the use of a porous electrode material that cannot make a liquid-tight seal with an o-ring and thus cannot be used with the first embodiment 200a that has a cavity 201 that is a through hole.

In both the first embodiment 200a and the second embodiment 200b, and as is the case with the cell block, the cavity 201 can include a counterbore 206 for placement of a sealing o-ring for sealing an electrode, membrane or separator material between the cell block and electrode plate. Either embodiment 200a, 200b of the electrode plate can use alignment holes 208 that align with alignment holes 108 of the cell block 100 and support the clamping of an electrode plate-cell block assembly. In one embodiment, the alignment holes 208 accommodate insertion of a screw sleeve that provides alignment between electrode plates and cell block. These sleeves provide a close sliding fit to the hexagonal bores in the clamping through holes 108 of the cell block to ensure alignment between sealing o-rings in cell blocks and electrode plates. The alignment holes 208 can also be surrounded by a protrusion that can rest in a recessed counterbore of the cell block. This is illustrated in FIGS. 16-18.

The electrode plate of the invention can be made of any suitable material. Typically, an inert material, including, but not limited to plastic, elastomer, composite, or ceramic, is utilized. The material can be transparent to light of a particular wavelength (UV, visible or IR) to allow for optoelectrochemical reactions. Inert materials can prevent contamination and the simple modular nature facilitates immersion in cleaning solution, and the low trapped volume allows for ease of cleaning and rapid drying.

In exemplary embodiments, the electrode plate can be a square with side lengths of about 2 in (5 cm) and a thickness of about 0.25 inch (0.64 cm). The cavity opening in the front can have a diameter of about 0.8 in (2 cm) and be centrally located in the electrode plate. When the second opening is on the top of the electrode plate, the electrode plate can be thicker, for example about 0.5 in (1.25 cm) and the opening can be about 1 in (2.5 cm) long and about 0.25 in (0.64 cm) wide. The top opening can be offset from the center of the electrode plate so that the rear wall (as defined by the solid back of the plate, is about 0.06 in (0.15 cm) thick.

### Cell Configurations

The modular nature of the system of the present invention allows for the assembly of a wide range of configurations that can include multiple electrodes, electrolytes, cell compartments, membranes and separators. The system allows for quick assembly, disassembly, cleaning and reassembly so that rapid and high throughput testing changeover can be achieved allowing for quicker and more efficient testing of electrochemical materials and processes and, accordingly, optimization. The use of components made from inert material with low trapped-volume enables rapid and efficient cleaning such that contamination of experiments is minimized. Any variable in the electrochemical reaction system can in principle be optimized using the present invention including electrodes, membranes, membrane materials, solvents, electrolytes, concentrations of electrolytes, processes, catalysts, reactant and reactant properties and concentrations as well as variations in temperature and other reaction parameters.

The configurations exemplified below are illustrative only. Persons skilled in the art will readily appreciate additional configurations that can be fabricated using the electrode plate(s) and cell block(s) of the invention described herein. The illustrated embodiments all utilize two electrode plates according to the invention. In practice, one of the electrode plates could be replaced by, for example, an electrode directly attached to a cell block or a differently constructed electrode plate, for example a solid plate that holds the electrode material in place could be used. Suitable configurations can be fabricated to mimic virtually any configuration that might be found in an electrochemical cell or that exemplify a larger scale cell.

### H-Cell Configuration

FIG. 16 illustrates an exploded view of a first configuration of a system according to the invention. In this configuration, a first electrode 301 is positioned between a first electrode plate 200 and a first cell block 100. A separator 302 can be positioned between the first cell block 100 and a second cell block 100′. The membrane or separator material 302 creates a seal to prevent cross-over of reaction products, for example oxidation and reduction products, produced within the two cell blocks. A second electrode 303 is positioned between the second cell block 100′ and a second electrode plate 200′. The first cell block 100 and second cell block 100′ may be identical or different, and each configured for a suitable purpose with necessary access ports, purging fillings and the like as described above. Any embodiment of the electrode plate can be used for electrode plates 200 and 200′. As described above, one of the electrode plates may be replaced by an electrode directly attached to the cell block or by a differently constructed electrode plate. If an open electrode plate is used, i.e. as in the first embodiment of an electrode plate 200a described above, potential contamination of the experiment by ancillary electrical components such as wires, clips, or conductive pastes/adhesives is avoided by locating these components external to the electrochemical reaction chambers. If a blind electrode plate is used, i.e. as in the second embodiment of an electrode plate 200b described above, the first or second electrodes contacting that plate can be replaced by a membrane or separator material.

The system can be assembled with seals 304 made using o-rings and clamping force provided by screws 305. In the illustrated embodiment, screws 305 extend through the alignment holes 208 of the electrode plates and engage with threaded sleeves 306 that are inserted into the clamping through holes 108 of the cell blocks 100, 100′. Alternatively, clamping force may be supplied by components other than threaded fasteners; including magnets, pneumatic/hydraulic forces, or “snap-to-connect” type fasteners.

### Three-Cell Configuration

FIG. 17 illustrates an exploded view of a second configuration of a system according to the invention. In this configuration, a first electrode 401 is positioned between a first electrode plate 200 and a first cell block 100. A first separator 402 can be positioned between the first cell block 100 and a second cell block 100′. A second separator 402′ is positioned between the second cell block 100′ and a third cell block 100″. A second electrode 403 is positioned between the third cell block 100″ and a second electrode plate 200′. The first cell block 100, second cell block 100′, and third cell block 100″ may be identical or different, and each configured for a suitable purpose with necessary access ports, purging fillings and the like as described above. Any embodiment of the electrode plate can be used for electrode plates 200 and 200′. As described above, one of the electrode plates may be replaced by an electrode directly attached to the cell block or by a differently constructed electrode plate. If an open electrode plate is used, i.e. as in the first embodiment of an electrode plate 200a described above, potential contamination of the experiment by ancillary electrical components such as wires, clips, or conductive pastes/adhesives is avoided by locating these components external to the electrochemical reaction chambers. If a blind electrode plate is used, i.e. as in the second embodiment of an electrode plate 200b described above, the electrodes contacting that plate might be replaced by a membrane or separator material.

The system can be assembled with seals 404 made using o-rings and clamping force provided by screws 405. The screws 405 may be of differing length (405a, 405b) located on opposing diagonals of the electrode plate and engaged with threaded sleeves 406 that may be in alternating cell blocks to ensure a sufficiently tight fit for secure assembly. In the illustrated embodiment, screws 405 extend through the alignment holes 208 of the electrode plates and engage with threaded sleeves 406 that are inserted into the clamping through holes 108 of the cell blocks 100, 100′. Alternatively, clamping force may be supplied by components other than threaded fasteners; including magnets, pneumatic/hydraulic forces, or “snap-to-connect” type fasteners.

The use of two membranes/separators 402, 402′ in addition to the presence of electrolyte confined in the second cell block 100′ reduces the occurrence of cross-over between channel or reaction compartments in the first cell block 100′ and third cell block 100″. The embodiment of FIG. 17 provides a wide range of variation in the type and nature of the medium and reactions being tested as each reaction compartment can be individually purged, filled, or circulated, etc.

### Zero-gap Configuration

FIG. 18 illustrates an exploded view of a third configuration of a system according to the invention. This configuration is illustrated using the second embodiment of an electrode plate 200b described above. In this configuration, a first electrode 501 is positioned between a first electrode plate 200 and a cell block 100. A second electrode plate 200′ is connected to the cell block 100 on the side opposite the first electrode plate 200. Because the illustrated embodiment utilizes the blind electrode plate 200b, as the second electrode plate 200′, a separator 502 can be positioned between the cell block 100 and the second electrode plate 200′. The use of an electrode plate 200′ with a blind pocket containing electrolyte (in this or any other configuration) enables locating the electrode inserted in the electrode plate 200′ at a short distance from the counter electrode 501 and thereby enables the combined cell assembly to be operated at a low overall cell voltage. If an open electrode plate (200a) is used as the second electrode plate 200′, the separator 502 is replaced by a second electrode 503 and potential contamination of the experiment by ancillary electrical components such as wires, clips, or conductive pastes/adhesives is avoided by locating these components external to the electrochemical reaction chambers.

The system can be assembled with seals 504 made using o-rings and clamping force provided by screws 505. In the illustrated embodiment, screws 505 extend through the alignment holes 208 of the electrode plates and engage with threaded sleeves 506 that are inserted into the clamping through holes 108 of the cell block 100. Alternatively, clamping force may be supplied by components other than threaded fasteners; including magnets, pneumatic/hydraulic forces, or “snap-to-connect” type fasteners.

### Other Configurations

Vertical Biphasic Configuration—This arrangement can be realized utilizing the H-cell configuration, the three cell configuration or others, however the assembly is rotated 90 degrees such that the plane of the membrane/separator materials is normal to the gravitational acceleration vector, i.e. the system is assembled in a horizontal plane so that current flows in a vertical direction. By orienting the system in this way, it is possible to conduct electrochemical testing of nonmiscible solutions on opposing sides of the membrane(s)/separator(s) with minimal cross-over of solution/products/electrolytes. As previously described, in this configuration the system facilitates rapid assembly, versatile testing of electrochemical processes and materials, ease of product sampling and analysis, while enabling efficient cleaning and low risk of contamination.

Optoelectrochemical Configuration—Using any of the previously described configurations, one or more of the electrode plates is made from an optically transparent (UV, visible, or IR) conductive material such as a conductive oxide, polymer, or other carbon derivative (i.e. graphene or carbon nanotubes). Alternatively, one or more of the cell blocks may be made from an optically transparent material such as a plastic, elastomer, or ceramic. This embodiment enables light to enter the cell and participate in chemical processes, facilitating optoelectrochemical evaluation of processes and materials.

### Uses

The components and system of the present invention can be utilized for the rapid evaluation of electrochemical processes. For example, the system can be used to test and evaluate solvents, electrolytes, concentrations of electrolytes, processes, reactants, reactant properties and concentrations of reactants, electrolytes, etc. used in electrochemical processes. They system can be used to determine the utility and efficacy of a reaction as well as optimization of reaction conditions. The components and system can also be used for the evaluation and testing of electrodes and electrode materials, membranes or separators and membrane or separator materials, solvents, electrolytes, concentrations of electrolytes, processes, and catalysts. More particularly, the system can be used for:
Electrolyte testing/screening.
Testing and evaluation of membranes/separator materials for use in electrochemical processes, for example electrolytic plating processes.

Solutions and components of the electrochemical cell can be rapidly removed, cleaned and reassembled in order to evaluate different materials, reactants, solvents, etc. For example, first and a second membrane material can be compared and evaluated by constructing a cell having a suitable configuration using the first membrane material, and performing the desired experiment and evaluating the results. The system is then readily disassembled by removing a small number of screws, cleaned and reassembled using the second membrane material in place of the first membrane material. A second experiment is performed and the results evaluated. Extensive set up of a second apparatus or complex disassembly and reassembly is avoided. Further, because the apparatus is otherwise identical, a direct comparison between the first and second membrane materials is accomplished; there are no other variables in apparatus to consider. Alternatively, using the three cell configuration, it may be possible to directly compare membrane materials by using different materials as the separators 402, 402′. Other components and reactants can be compared using a similar procedure.

The system can be operated using liquids including aqueous or non-aqueous electrolyte or mixtures thereof, gases, or liquids saturated with a gaseous component. The system can be operated using gas-phase or liquid feed stock and used to test evaluate and optimize feedstock identities, concentrations and other reaction conditions. The system may be operated at any temperature suitable for the material used and the nature of the electrochemical reaction being evaluated, and the material can be varied to accommodate a wide range of temperatures. In a typical operating environment, temperatures may range from about 0° C. to about 150° C., although it may be operated outside of those temperature ranges. The system may be operated at any pressure suitable for the material used and the nature of the electrochemical reaction being evaluated, and the material can be varied to accommodate a wide range of pressures. In a typical operating environment, pressures may range from about 0.5 atmospheres to about 3 atmospheres, although it may be operated outside of those pressure ranges. Multiple embodiments of the system may be used in parallel or in series to accomplish multi-step electrochemical processes.

The system may be utilized by an automated system capable of assembly, operation, analysis, disassembly, and cleaning without the involvement of a person. In this case, assembly, operation, analysis, disassembly, and cleaning may be implemented as sets of instructions or software readable by a device.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. The accompanying methods present elements of the various steps in a sample order, and are not necessarily meant to be limited to the specific order or hierarchy presented. It is therefore to be understood that, within the scope of the claims and their equivalents, the invention may be practiced otherwise than as specifically described.

1. A system for fabricating an electrochemical cell comprising a first cell block and a first electrode plate attachable to the first cell block;
the first cell block comprising a front surface, a back surface and a top surface, the front surface and the back surface being substantially parallel and the top surface being substantially perpendicular to the front surface and the back surface;
an opening in the front surface and extending through the first cell block to an opening in the back surface to form a first channel extending from the front surface to the back surface; and
a third opening in the top surface extending through the first cell block from the top surface to the first channel to form a second channel, wherein the first channel and second channel are substantially perpendicular to one another; and
the first electrode plate comprising
a front surface, a back surface and a top surface, the front surface and the back surface being substantially parallel and the top surface being substantially perpendicular to the front surface and the back surface;
a first opening in the front surface of the first electrode plate defining a cavity; and
a second opening in the first electrode plate, wherein the second opening is in one of the top surface or the back surface of the first electrode plate and the first opening connects to the second opening.

2. The system of claim 1, further comprising a second electrode plate, wherein the first electrode plate and the second electrode plate may be the same or different.

3. The system of claim 1, the first cell block further comprising alignment openings in the front and back surfaces for aligning and/or attaching the first cell block with the first electrode plate.

4. The system of claim 1, the first cell block further comprising a lower hole extending from the right or left surface of the first cell block to the first channel and an upper hole between the lower hole and the top of the first cell block extending from the right or left surface of the first cell block to the first channel or the second channel.

5. The system of claim 4, the first cell block further comprising a second lower hole extending from the left or right surface of the first cell block opposite the surface having the lower hole to the first channel.

6. The system of claim 1, the first electrode plate further comprising alignment openings in the front and back surfaces for aligning and/or attaching the first electrode plate to the first cell block.

7. The system of claim 1, wherein the second opening in the first electrode plate is in the top surface and the back surface of the first electrode plate is solid and a bore connects the cavity to the second opening.

8. The system of claim 1, wherein the second opening in the first electrode plate is in the back surface and the cavity forms a channel extending from the front surface to the back surface.

9. The system of claim 1, further comprising a separator or an electrode positionable between the first cell block and the first electrode plate.

10. The system of claim 9, further comprising at least one O-ring positionable between the first electrode plate and the separator or electrode or between the first cell block and the separator or electrode.

11. The system of claim 2, wherein the second electrode plate is attachable to the first cell block.

12. The system of claim 2, further comprising a second cell block and wherein the second electrode plate is attachable to a second cell block and the first cell block is attachable to the second cell block.

13. The system of claim 2, further comprising a second cell block and a third cell block wherein the second electrode plate is attachable to the third cell block and the second cell block is attachable to the first cell block and the second cell block.

14. A kit comprising the system of claim 1.

15. A cell block comprising
a front surface, a back surface and a top surface, the front surface and the back surface being substantially parallel and the top surface being substantially perpendicular to the front surface and the back surface;
an opening in the front surface and extending through the first cell block to an opening in the back surface to form a first channel extending from the front surface to the back surface; and
a third opening in the top surface extending through the first cell block from the top surface to the first channel to form a second channel, wherein the first channel and second channel are substantially perpendicular to one another.

16. The cell block of claim 15, further comprising a lower hole extending from the right or left surface of the cell block to the first channel and an upper hole between the lower hole and the top of the cell block extending from the right or left surface of the cell block to the first channel or the second channel.

17. The cell block of claim 15, further comprising a second lower hole extending from the left or right surface of the first cell block opposite the surface having the lower hole to the first channel.

18. An electrode plate comprising
a front surface, a back surface and a top surface, the front surface and the back surface being substantially parallel and the top surface being substantially perpendicular to the front surface and the back surface;
a first opening in the front surface of the first electrode plate defining a cavity; and
a second opening in the first electrode plate, wherein the second opening is in one of the top surface or the back surface of the first electrode plate and the first opening connects to the second opening.

19. The electrode plate of claim 18, wherein the second opening is in the top surface and the back surface is solid, and
a bore connects the cavity to the second opening.

20. The electrode plate of claim 18, wherein the second opening in the first electrode plate is in the back surface and the cavity forms a channel extending from the front surface to the back surface.
